(19) United States
(12) Patent Application Publication
(10) Pub. No.: US 2008/0051994 A1
(43) Pub. Date: Feb. 28, 2008

(54) REPRESENTATION AND DISPLAY OF GEOGRAPHICAL POPULARITY DATA

(75) Inventors: Danyel Aharon Fisher, Seattle, WA (US); Paul Roger Johns, Tacoma, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/467,789

(22) Filed: Aug. 28, 2006

(51) Int. Cl. G01C 21/30

(52) U.S. Cl. 701/210

(57) ABSTRACT

The popularity of geographical points, locations or regions is represented and displayed by software in a computing system. Geographical popularity data may be stored according to a hierarchical naming convention that maps to geographical detail levels, and the geographical popularity data may be updated, e.g., continually or periodically, to maintain real-time, dynamic popularity measurements. The geographical popularity data can be represented according to different hierarchical levels of geographical detail. One visualization technique includes displaying the geographical popularity data as a chloropleth enabling a user to observe variation of the popularity of geographical sub-regions within a greater geographical context.

### TECHNICAL FIELD

The present invention relates generally to the representation and display, e.g., visualization, of geographical popularity data in a computing system.

### BACKGROUND

Today, users interact with software in a myriad of ways that implicate geographical aspects. For instance, for a variety of applications and services, users may have some geographical interest(s) in mind, or otherwise evince geographical intent, when interacting with the software. In this regard, there are varieties of ways in which users might express such geographical interests or intent, which either explicitly or implicitly specify an interest in some part of the physical real world outside of virtual computing space.

However, not all geographical locations and regions are equal in a popularity sense. While a user knows this intuitively based on real-world experiences, in contrast, computing devices do not have a native intelligence of these inequalities. Simply put, the middle of the Sahara Desert and the deepest parts of the Pacific Ocean are not like Manhattan or downtown Tokyo in that the latter are of much greater interest to people than the former (more popular). In essence, where a user does not know a lot about a specified geography of interest (e.g., the user may be visiting a certain location on vacation for the first time), a user might also wish to learn about the popularity of the specified geographical area(s). However, today, this information is unavailable to the user because software applications, such as mapping and search software programs, do not have a way of presenting any geographical popularity data to a user.

Accordingly, it would be desirable to represent geographical popularity data, and display the geographical popularity data in connection with an explicitly or implicitly specified geographical location or area. It would be further desirable to represent dynamic geographical popularity data in which popularity values continually change according to a dynamic popularity determining function. It would be further desirable to represent and display geographical popularity data according to different hierarchical levels of geographical detail, so that popularity variation within a specified geographical hierarchical level is observable by the user.

Other deficiencies in the state of the art of geographical interaction applications and services in a computing system will also become apparent upon review of the following description of various exemplary, non-limiting embodiments of the invention.

### SUMMARY

In view of the foregoing, the present invention provides systems and methods for representing and displaying the popularity of geographical locations or regions in connection with specified geographical points, locations or regions. Geographical popularity data may be stored according to a hierarchical naming convention that maps to geographical detail levels, and the geographical popularity data may be updated, e.g., continually or periodically, to maintain real-time, dynamic popularity measurements with respect to the underlying geographical popularity data. The geographical popularity data can be represented according to different hierarchical levels of geographical detail. One way to visualize the geographical popularity data is to display the data as a chloropleth enabling a user to observe variation of the popularity of geographical sub-regions within a greater geographical context and thus to quickly gain a sense of the relative popularity of a given sub-region within the greater geographical context.

A simplified summary is provided herein to help enable a basic or general understanding of various aspects of exemplary, non-limiting embodiments that follow in the more detailed description and the accompanying drawings. This summary is not intended, however, as an extensive or exhaustive overview of the subject matter of the invention. The sole purpose of this summary is to present some concepts related to the various exemplary non-limiting embodiments of the invention in a simplified form as a prelude to a more complete description of those concepts and various other features of the present invention described below.

### BRIEF DESCRIPTION OF THE DRAWINGS

The systems and methods for representing and displaying geographical popularity data are further described with reference to the accompanying drawings in which:

FIGS. 1A, 1B, 1C and 1D illustrate exemplary, non-limiting formats for web log data structures in accordance with the invention;

FIG. 2 illustrates an exemplary, non-limiting format for a geographical popularity data structure in accordance with the invention;

FIGS. 3 and 4 are block diagrams representing exemplary hierarchical levels of geographical data, and a subdividing process for subdividing the hierarchical levels that corresponds to a hierarchical naming convention;

FIG. 5 is a flow diagram representing an exemplary non-limiting process for visually representing geographical popularity data in accordance with the invention;

FIGS. 6A and 6B are exemplary screen log data structures that may be utilized in connection with the present invention;

FIG. 7 is a flow diagram representing an exemplary non-limiting process for reducing screen representations to popularity data records in accordance with the invention;

FIG. 8 is a block diagram further illustrating processes for reducing screen representations to popularity data records in accordance with the invention;

FIGS. 9A, 9B, 9C, 9D and 9E conceptually illustrate varying levels of hierarchical visualization of geographical popularity data in accordance with the invention;

FIGS. 10A, 10B and 10C illustrate, by way of exemplary choropleth representations, varying levels of hierarchical visualization of geographical popularity data in accordance with the invention;

FIG. 11 is a block diagram representing an exemplary non-limiting networked environment in which the present invention may be implemented; and

FIG. 12 is a block diagram representing an exemplary non-limiting computing system or operating environment in which the present invention may be implemented.

### DETAILED DESCRIPTION

As mentioned in the background, today, users interact with software in a variety of ways that implicate geographical point(s), location(s), or area(s) of interest, though there is no way for the user to assess the popularity of a geographical result set returned by an application or service in a computing system.

For an illustrative scenario, a user might explicitly specify an interest in geography when typing in an address to real-world mapping software, such as MapPoint.com. Generally, in such cases, the user is interested in discovering some relative location information about the specified address, e.g., how to drive to that address from a designated starting point, or “where the address is” in a greater geographical context. In the driving directions case, in addition to explicitly designating a target address, the user might implicitly designate a starting address and a geographical path between the starting address and the target address as well.

For another example, users might explicitly or implicitly specify an interest in geography when searching in a search engine. For instance, trying to discover vendors of a particular type in a particular city might involve typing the search terms “Home Depot Seattle” to find out where the nearest Home Depot is in Seattle, in which case the user has explicitly designated Seattle as a geographical point of interest. If it turns out that there is no Home Depot is in Seattle, Wash. and the nearest Home Depot is in Bellevue, Wash., for instance, then the user has implicitly specified Bellevue, Wash. as a geographical interest.

One can appreciate that these are merely two examples in which a user might interact with a software application or service, whether networked or standalone, whether distributed, local or at a server, wherein the user either explicitly or implicitly specifies an interest in a physical location or geographical region.

Accordingly, the invention enables the representation and visualization of geographical popularity data in connection with explicitly or implicitly specified geographical points, locations or areas. In one non-limiting embodiment, geographical popularity data is stored and updated, e.g., continually or periodically, to maintain dynamic popularity measurements with respect to the underlying geographical data that is up to date. Accordingly, as a geographical location becomes more or less popular, the geographical popularity data associated with the geographical location becomes more or less popular in a corresponding manner.

In other non-limiting embodiments, the invention enables the storage and display of geographical popularity data according to different hierarchical levels of geographical detail, e.g., via a chloropleth. As a result, a user can observe variation of the popularity of geographical sub-regions within a greater geographical context and quickly gain a sense of the relative popularity of a given sub-region within the greater geographical context.

For illustrative purposes, one exemplary non-limiting class of software applications that implicate geographical locations is on-line geographical and mapping programs, such as MapPoint, Windows Live Local, Google Maps, etc. With these services, the server software implementation generally logs usage behavior in data storage known as the server log. Where millions of users are anticipated, the server log has extensive memory requirements, and is generally represented in a relational database for fast and efficient storage and access, though any storage construct may work with the representation of geographical popularity data in accordance with the invention. Another class of software applications that implicate geographical locations is on-line search software, which may record geographical records as part of a search log. It can be appreciated that varieties of other classes of software applications or services that implicate geography exist as well.

In accordance with one embodiment of the invention, server log(s) associated with online geographical and mapping programs are examined with respect to usage of geographical locations and regions by users, and a popularity score or level, e.g., value, is determined and assigned to each of the geographical components, e.g., “tiles,” with which users interact. In one exemplary, non-limiting embodiment of the invention, rather than merely aggregating counts of individual scenes, or tiles, a visualization of the collective popularity of different areas of the world is presented to the user, as represented by how many times tiles have been downloaded.

In another embodiment, the collective popularity of different areas of the world is represented as a colored map, e.g., a chloropleth, which shows how visually popular different parts of the underlying dataset are relative to one another.

In this regard, formally, a chloropleth is a map using symbols, often a series of shadings or colors, on geographic subdivisions to represent each subdivision's level in a range of values. Chloropleth mapping displays quantitative or qualitative information about subentities of a map in terms of symbols or colors. Such visual display of information is a highly efficient method for conveying information visually to a user in an intuitive manner. Regional correlations are easily seen in such a display, especially if the color codes represent a gradient of colors. The choropleth is thus a good example of a map that is suited to representing geographical popularity data determined in accordance with the invention, though, one can appreciate that there are almost limitless ways to present the popularity scores recorded for geographical areas in accordance with the invention.

Thus, in an exemplary, non-limiting embodiment, the invention displays a chloropleth for a specified geographical region that indicates the ways that users have used the system in connection with the specified geographical region and its sub-regions. In one implementation, brighter or more intense colors suggest a more popular part of the map while dimmer or faded colors suggest a less popular section.

In one embodiment, past navigation information, e.g., in the form of web logs, is used to visualize usage data as a proxy for popularity of the underlying geographical regions and sub-regions. In one non-limiting implementation, web logs are produced in at least one of two forms: (A) Tile server logs, which constitute a list of tiles that were downloaded and the time that they were downloaded and/or (B) Screen logs, which constitute a list of users' points of view. Other log data that is indicative of user's interest in geographical areas or locations, such as search log data, may also supplement, or separately provide, measures of the popularity scores for geographical areas or locations.

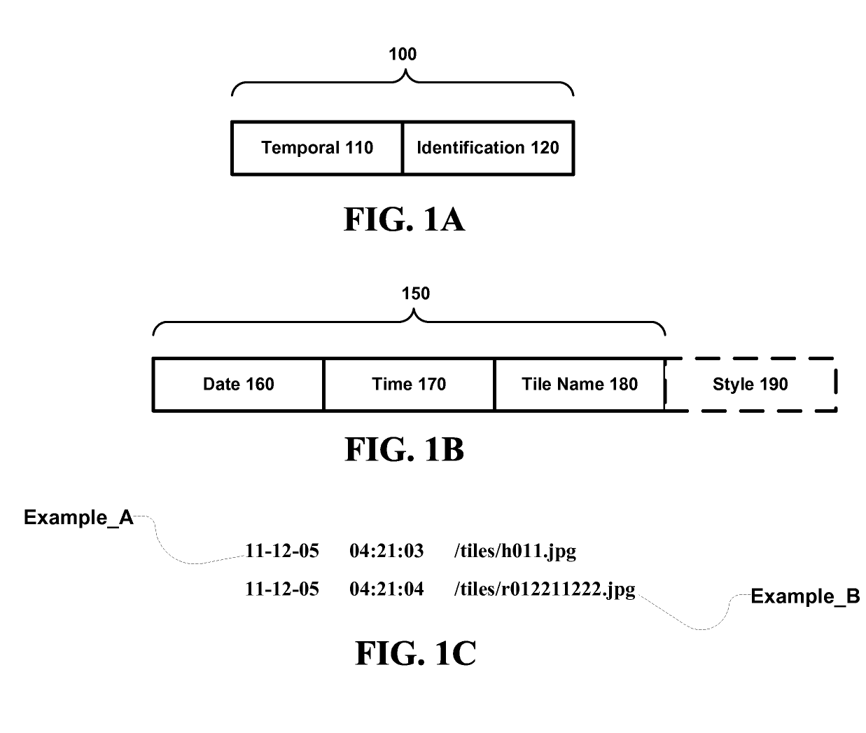

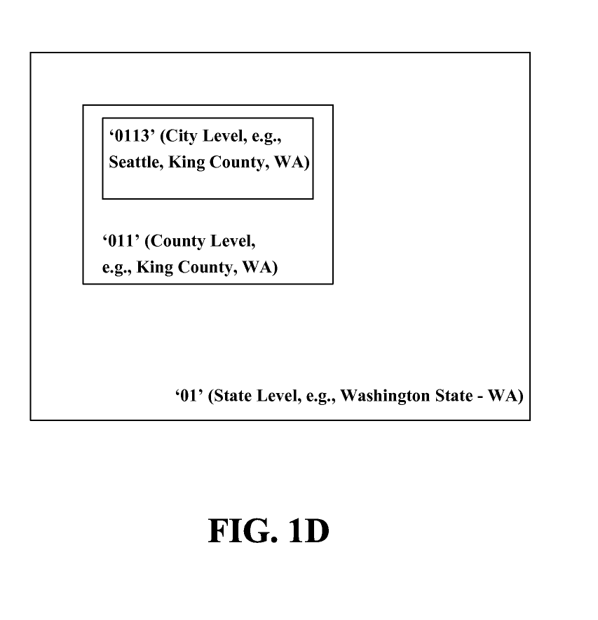

As shown in FIG. 1A, a tile server log, or record, 100, for example, might contain (among other fields) a temporal field 110 indicative of a date and/or time, and an identification field 120 that uniquely identifies the geographical location or area. Another more detailed example of a tile server log 150 is illustrated in FIG. 1B, wherein a date field 160 for representing a date of interaction with the associated geographical subcomponent, a time field 170 for representing a time of interaction with the associated geographical subcomponent and a name field 180 for naming the geographical subcomponent with which the user interacts (e.g., downloads) are included. In addition, tiles can optionally be specified with a ‘style’ 190. For instance, styles 190 may include ‘r’, ‘h’, and ‘a’ (for Road, Hybrid, and Aerial views).

As shown in FIG. 1C, examples of tile server log 150 include Example_A and Example_B. Example_A and Example_B show the tile server log records for two hypothetical tiles downloaded at two different times on the same day in connection with some activity by a user that implicates a geographical location or area represented by the tile, including date and time of download and the name of the tile.

In one non-limiting implementation, for hierarchical convenience, tiles are advantageously named as hierarchical names referring to increasing zoom levels of a geographical region represented by the tile, i.e., the higher the zoom level, the smaller the size of real space represented by the tile. Thus, as illustrated by the hierarchical block diagram of FIG. 1D, the location as designated by file name ‘011’ (e.g., County level) is immediately “below” the location ‘01’ (e.g., State level), i.e., ‘011’ is a sub-region of ‘01’; and ‘0113’ (e.g., City level) is, in turn, “below” ‘011’ (County level) as a sub-region of ‘011’. Styles 190 may be incorporated into the file name too, such as in Example_A and Example_B showing styles H (Hybrid) and R (Road), respectively.

One can appreciate that any kind of data store is suitable for storing the geographical popularity data of the invention. Accordingly, the following description of an exemplary, non-limiting implementation and naming convention pertain to one optimal representation of the data that takes into account geographical hierarchy in the file naming convention for fast and efficient querying, access and retrieval of the data.

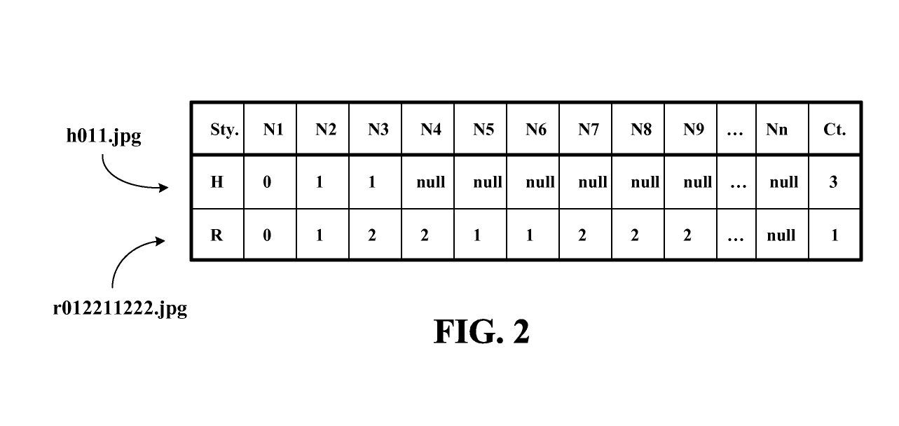

In this regard, to reduce the data to a common form, in one embodiment of the invention, the server log is parsed and stored in a database, thereby storing the tile names as separable, queryable units. Thus, for instance, as shown in FIG. 2, the names of exemplary log entries Example_A and Example_B are stored as records having an optional style column Sty, and name columns N1, N2, N3, N4, N5, N6, N7, N8, N9, . . . , Nn for each character of the tile name up to a maximum name length n (corresponding to a maximum zoom level of detail). Where an actual tile name is shorter than the maximum name length, the values are assigned NULL signifying the end of the name. It is noted that the representations of Example_A and Example_B in FIG. 2 include the style Sty as a separate, optional column.

In addition, a database in accordance with the invention stores quantities of ‘hits’ on the tiles. Accordingly, in various non-limiting embodiments of the invention, when a new hit comes into the database pertaining to a particular geographical tile, an additional count column Ct. shown in FIG. 2 processes and stores the increment associated with the particular geographical tile.

Dividing the tile name into individual columns in accordance with the presently described implementation advantageously enables careful discrimination and optimization of how tiles are retrieved from the data store. For instance, suppose tiles at level 15 have a 15-character name (n=15) and correspond to a 20 meter resolution and also suppose that the goal is to determine the number of times that users have looked at certain tiles at level 15, i.e., to determine how popular the images are at a 20-meter resolution. Due to the naming convention of the invention, the popularity data for the tiles can be retrieved at level 15 via a query that targets the popularity of level 15 tiles.

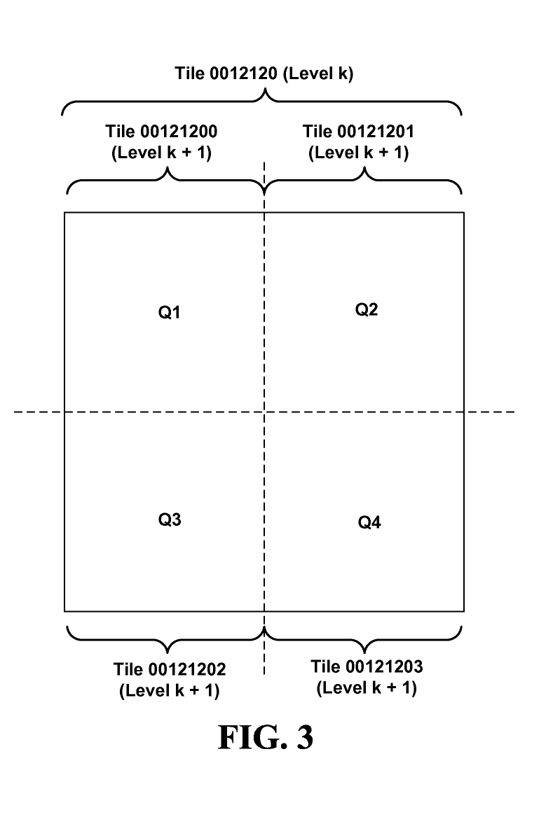

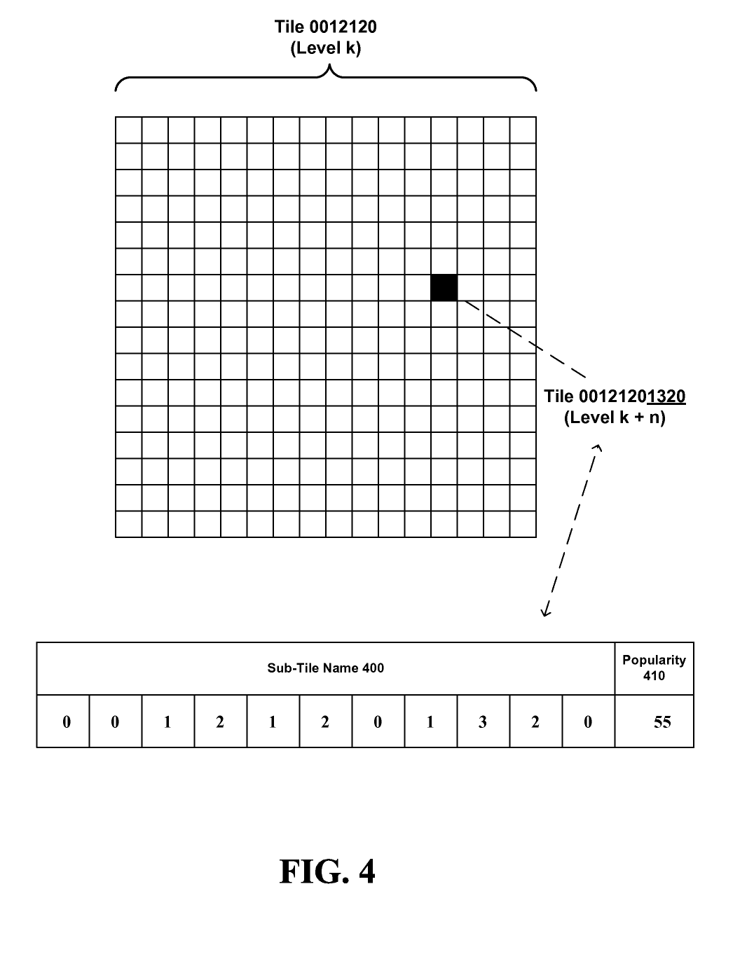

In this regard, the way the naming hierarchy maps to tiles and subdivisions of those tiles and level hierarchies is illustrated in FIG. 3 and FIG. 4. As shown in the diagram of FIG. 3, a tile at level k of the hierarchy can be further sub-divided into 4 quadrants at level k+1 of the hierarchy. At level k+1, the tiles have the same name as the tile at level k, except for the addition of a character corresponding to the quadrant sub-divisions. For instance, where the tile at level k is named 0012120, the tile of quadrant Q1 receives the name 00121200, the tile of quadrant Q2 receives the name 00121201, the tile of quadrant Q3 receives the name 00121202 and the tile of quadrant Q4 receives the name 00121203. Thus, a tile is subdivided into sub-tiles that share a prefix.

FIG. 4 expands these concepts from division of a tile at level k to sub-divisions at level k+1 to division of a tile at level k to sub-divisions at level k+n, wherein the tile at level k is successively sub-divided n times. FIG. 4, in particular, shows the situation where n=4, i.e., the tile at level k is sub-divided 4 times to create 256 (4⁴) sub-tiles. Sub-tile 00121201320 of tile 0012120 is shown. In the first sub-division of tile 0012120, sub-tile 00121201320 is in the second quadrant, in the second sub-division of tile 0012120, sub-tile 00121201320 is in the fourth quadrant, in the third sub-division of tile 0012120, sub-tile 00121201320 is in the third quadrant, and in the fourth sub-division of tile 0012120, sub-tile 00121201320 is in the first quadrant. Thus, at level k+4, 1320 is added as a child suffix to the parent tile prefix of 0012120 to name sub-tile 00121201320. This example sets k=7 and n=4, illustrating sub-tiles at a level 11. With respect to the hypothetical example above concerning tiles at level 15, similar ‘query on name’ techniques can be used to gather data associated with level 15 tiles, i.e., by querying over the hierarchy of the columns used for naming geographical areas or locations (e.g., tiles) to efficiently extract scores for geographical areas or locations at level 15 detail.

Thus, in accordance with the invention, each tile and sub-tile, as uniquely named according to the hierarchy includes a popularity count, which is a measure of the popularity of a given geographical tile at a given hierarchical level. In one embodiment, the measure of popularity is how often the tile is downloaded from the database for presentation to a user as part of a software application or service.

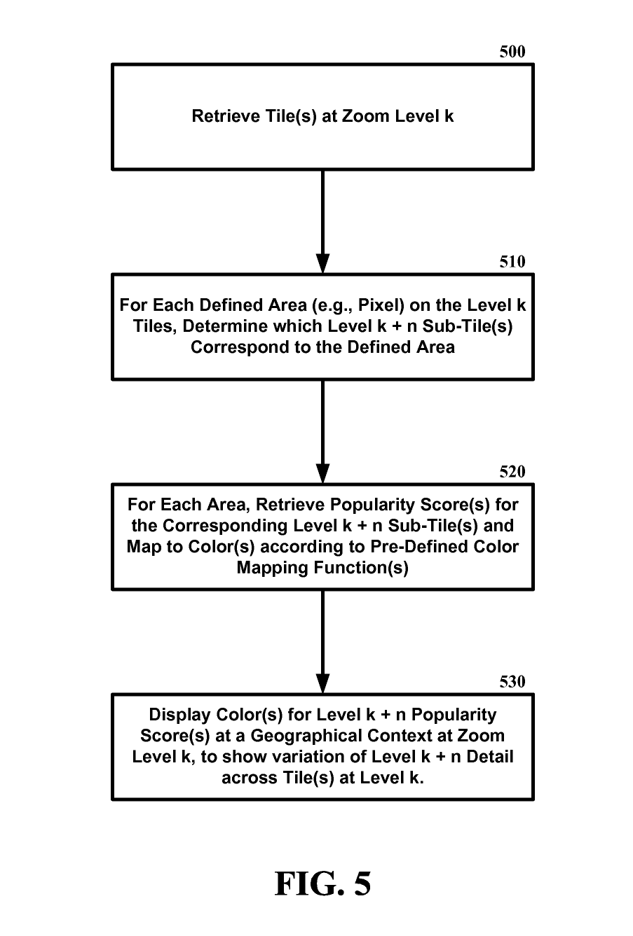

Thus, when looking at a tile at level k, with an offset of n, a query can be performed on its 4̂n children and then colors are assigned that correspond to the popularity of those children, e.g., a range of colors from light to dark, light to dim, etc. to indicate relative popularity of sub-tile areas. In one embodiment of the invention, as shown in the flow diagram of FIG. 5, when displaying popularity data relating to the children, at 500, a user interface displays some number of tiles at a lower level k, e.g., level 7. Then, at 510, for each area (e.g., for each pixel) on the level k tiles (e.g., level 7 tiles), the invention calculates which level k+n (e.g., level 15 tiles) correspond to those areas. Then, at 520, each area (e.g., pixel) is colored according to a pre-defined color scheme that maps a range of colors, brightness range, range of shading, etc. to the popularity scores at level k+n (e.g., level 15). The resulting display of those colors at 530 shows a map at level k scope (e.g. zoom at level 7) that visually represents popularity scores varying across the level k tiles (e.g., level 7 tiles) according to level k+n detail (e.g., scores at level 15).

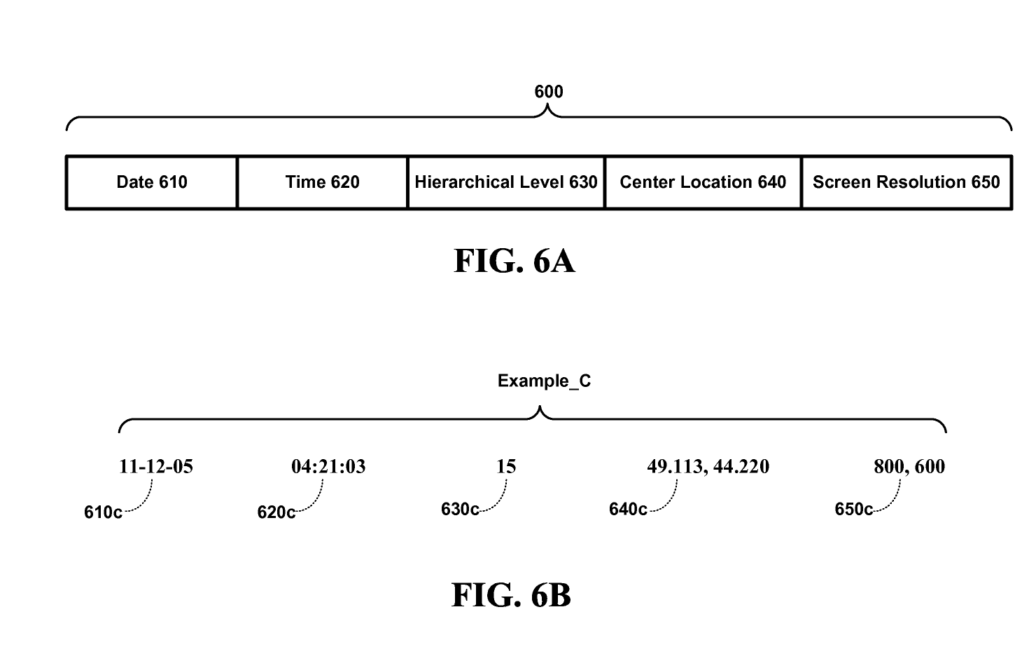

As mentioned, in addition to extracting popularity data from web logs as described above, geographical popularity information may also be extracted from screen logs. In general, a goal of a screen log is to represent that a user looked at (or at least downloaded for display on the user's screen) a particular geographical area, location or point, as noted by a zoom level, center, and screen resolution. As shown in FIG. 6A, an exemplary non-limiting screen log 600 may record the following information when a user interacts with (e.g., downloads for display) various geographical images, or tiles, at one or more geographical detail or zoom levels: (A) date field 610 for representing the day of user interaction, (B) time field 610 for representing the time of day of user interaction, (C) a hierarchical level field 630 for indicating a level of detail for images on display, (D) a center location field 640 representing a position of the geographical images on display that is located at the center of the geographical images and (E) a screen resolution field 650 that specifies the resolution of the display of the geographical images. Thus, hierarchical level 630, center location 640 and screen resolution 650 together specify what a user was looking at any given time 620 and date 610. For instance, as illustrated in FIG. 6B, an exemplary screen log instance Example_C of screen log format 600 shows a date 610c, a time 620c, a hierarchical level 630c, a center position 640c in 2-D screen space and a screen resolution 650c.

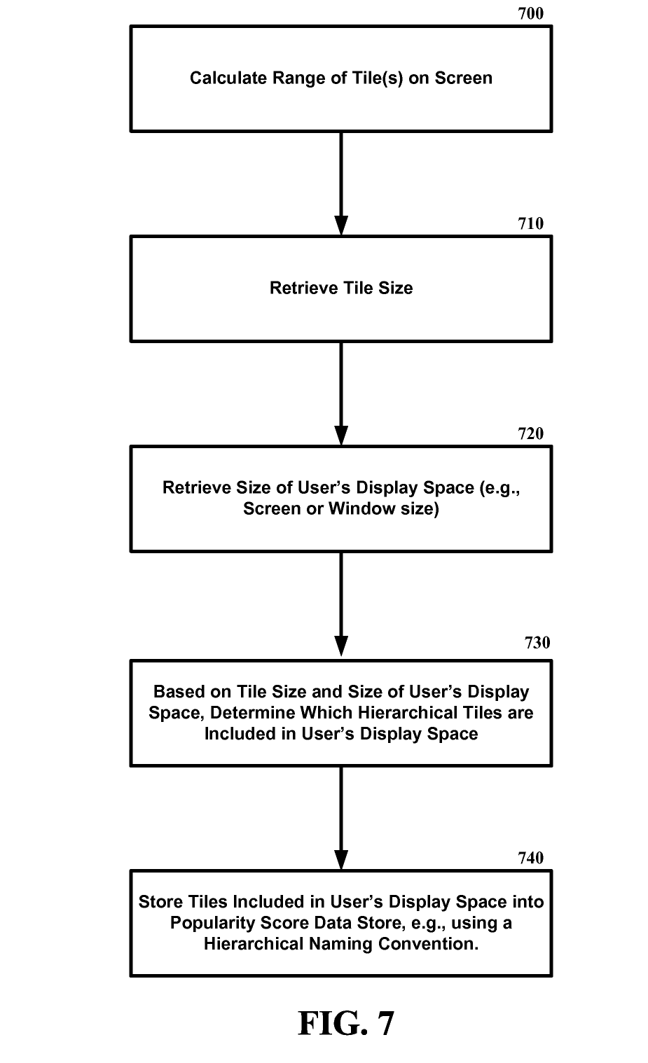

In accordance with an exemplary, non-limiting embodiment of the invention, as shown in the flow diagram of FIG. 7, an exemplary screen log is created starting at 700 when a range of tiles is calculated according to what was visible on a user's screen at a given time by knowing the tile size at 710, and the size of the user's screen at 720, and calculating which points in space are controlled by which tiles at 730. At 740, those tiles can then be stored into a data store, e.g., a data store using the data format of FIG. 2, according to the hierarchical naming convention described above, or into a separate data store following the same or different naming convention.

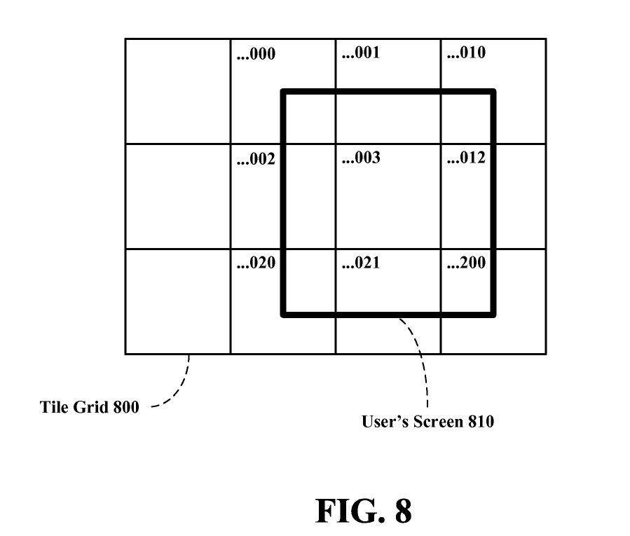

FIG. 8 illustrates steps 700 to 730 conceptually via an exemplary block diagram. At a time t, a user's screen 810 covers a subset of tiles of tile grid 800 representing a greater geographical context than the user's screen 810. In this regard, a user peering at user's screen 810 can only see tile . . . 003 in its entirety, and parts of tiles . . . 000, . . . 001, . . . 010, . . . 002, . . . 003, . . . 012, . . . 020, . . . 021 and . . . 200. The complete names of the tiles are obscured via the ellipses in order to show that the process of FIG. 7 can be applied at any hierarchical level of tile size. Thus, the task is to determine which tiles are covered by the user's screen. Thus, by retrieving or otherwise knowing the tile size represented by tile grid 800, i.e., the hierarchical level of detail or zoom characterizing the geographical information of the tiles, and also by retrieving or otherwise knowing the size of the user's screen, a range of tiles is calculated according to what was visible on a user's screen at a given time, i.e., the tiles included anywhere within the bolded lines of user's screen 810. In one embodiment, any tile within user's screen 810 records into the popularity score data store equally. However, optionally, partially shown tiles can be assigned a correspondingly reduced popularity score because of their limited screen exposure compared to a fully shown tile, such as . . . 003.

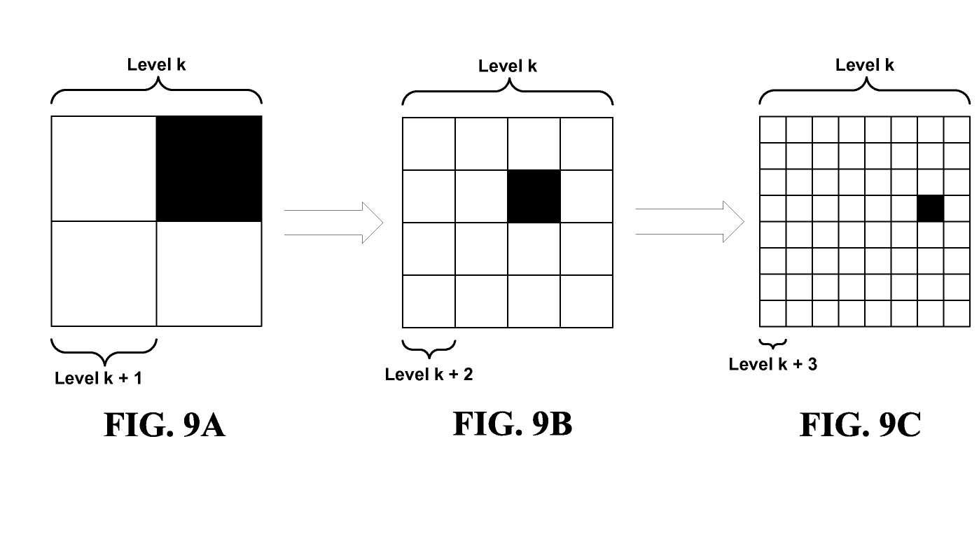

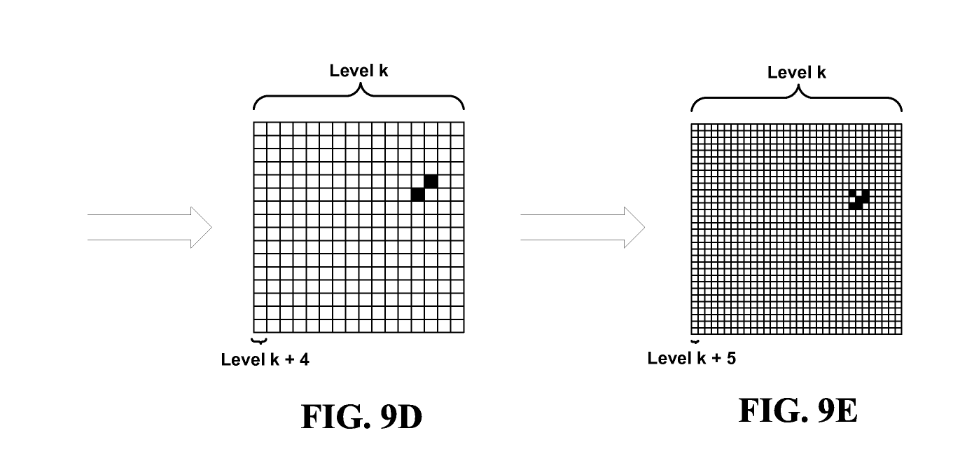

FIGS. 9A to 9E each illustrate a color map at a constant hierarchical level k for display size. The popularity information stored for tiles in accordance with the invention are then displayed in FIGS. 9A to 9E at increasing level of detail by increasing the offset n from 1 to 5, respectively. The popularity scores for tiles become more meaningful as the offset increases due to greater granularity and representation of more acute variations as the offset increases. While a chloropleth is utilized in one embodiment of the invention, a simple color map showing a popular area (e.g., an oasis) in black in the midst of an unpopular region at level k (e.g., the desert), reveals that there is a popular part of the map (the black squares).

FIG. 9A, for instance, shows the popularity scores for sub-tiles at offset 1, i.e., at hierarchical level k+1. It is clear that this level of detail does not give adequate information to the user, however, because the black sub-tile covers a lot of the area which may be misleading. This becomes more clear in FIG. 9B, showing popularity scores for sub-tiles at offset 2, i.e., at hierarchical level k+2. This is more helpful information than the map of FIG. 9A. FIG. 9C shows the popularity scores for sub-tiles at offset 3, i.e., at hierarchical level k+3, showing further improvement in granularity concerning where the popular spot on the map is. At still greater level of popularity score detail, FIG. 9D shows the popularity scores for sub-tiles at offset 4, i.e., at hierarchical level k+4. Finally, with FIG. 9E showing the popularity scores for sub-tiles at offset 5, i.e., at hierarchical level k+5, an appropriate level of detail can be discerned visually from the color map, and a user will know exactly where the popular spots are on the map represented at level k.

An optimal offset of 5 is merely an exemplary design choice, and any offset may be utilized to represent popularity score detail in sub-tiles. For instance, the optimal offset may depend on the level of detail required for a particular application, e.g., whether a user is “looking for a needle in a haystack” (difficult to spot) or “looking for a bull in a china shop” (easy to spot). In short, the level at which the screen is displayed (level k) can be set independent of the detail level displayed (offset n).

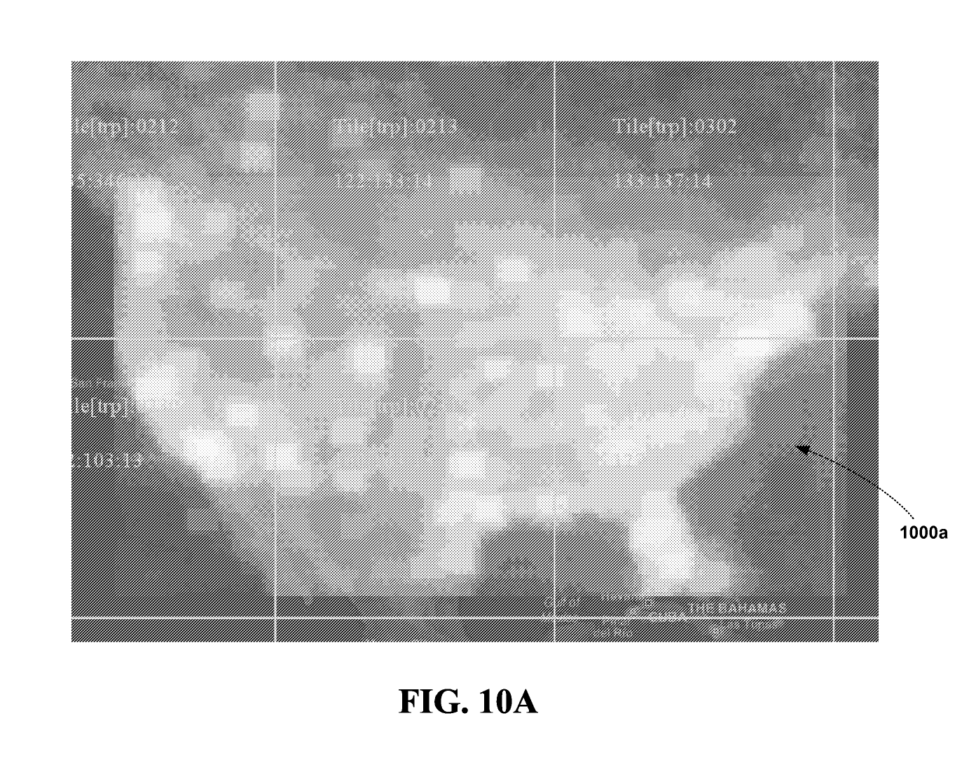

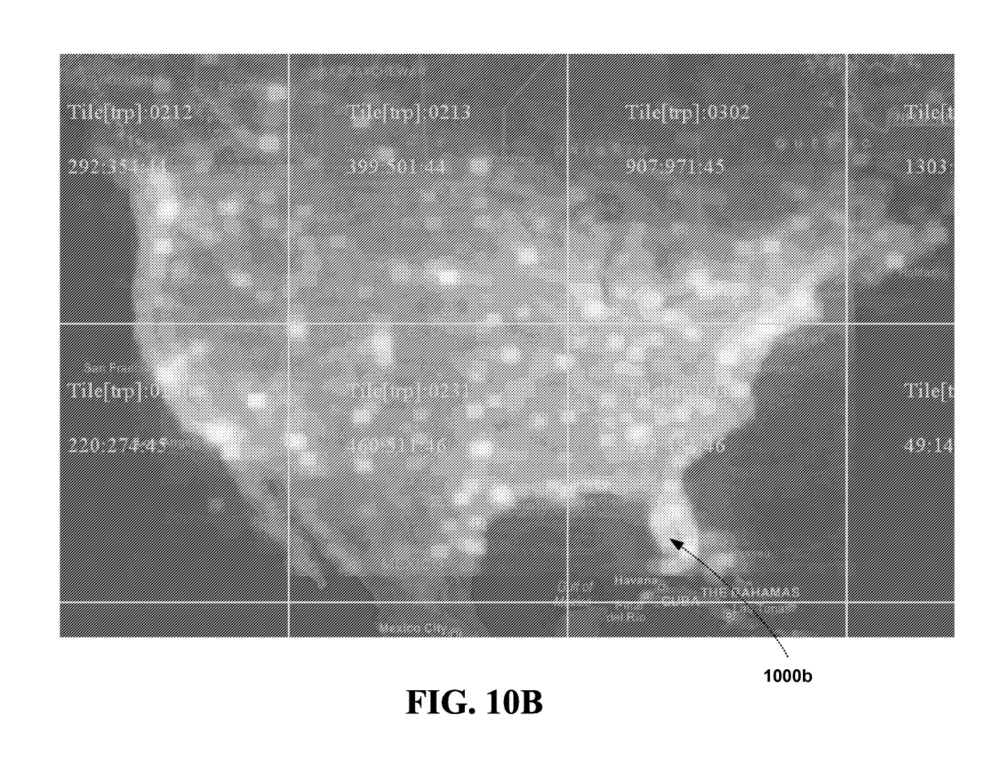

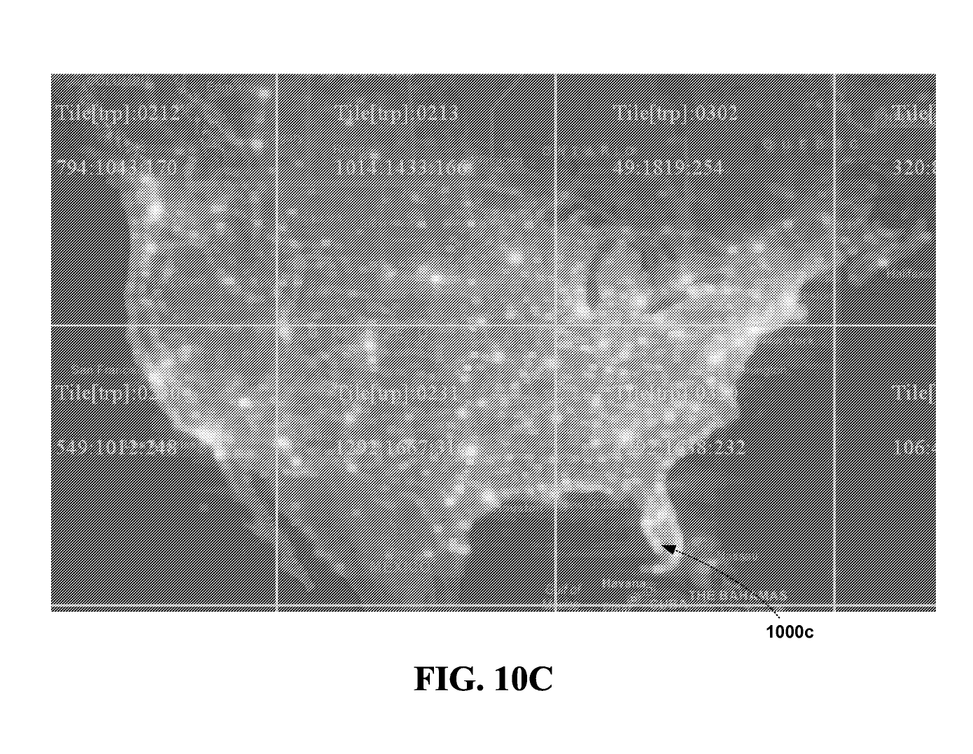

FIGS. 10A, 10B and 10C illustrate particular chloropleths 1000a, 1000b and 1000c, respectively, generated using the popularity score data of the invention wherein the hierarchical level k is held constant, but the popularity score data is presented visually at increasingly smaller sub-tiles. The data in FIG. 9A is too blurred in chloropleth 1000a and a user cannot discern with any visual exactitude as to where the popular spots in North America are. The data in chloropleth 1000b is more granular than the data in chloropleth 1000a, but still, a user is left only with a general sense of where the popular spots are in North America. Lastly, however, one can see from chloropleth 1000c where many of the popular, or interesting, places in North America are because the data is presented in a reasonably detailed manner. The same techniques can be applied at a city level, a district level, and even on a “house by house” street level. As mentioned, any implication of geography, whether express or implied by a user, can be taken as a recording event for a web or usage log for storing geographical popularity information in accordance with the invention.

Thus, the invention enables interpretation of geographical server logs and usage data as indications of a users' intent, and then enables the representation, e.g., visualization, of those geographical logs over maps, as chloropleths or other map-based visualizations.

The technique may be extended in ways to filter for specific time slices, specific tile types, specific locations, or different originating IP addresses. For instance, with respect to time slicing, by recording when certain tiles are popular, additional information can be extracted by a geography. If, for example, New Orleans becomes super popular at Mardi Gras, for instance, that popularity can translate to potential advertising dollars during that time knowing about its enhanced popularity at a time, or time interval. With respect to specific tile types, popularity data can be filtered on the type of tile, so that only “road” tiles are taken into account when visually displaying popularity scores for traffic based applications via a chloropleth, for instance. With respect to specific locations, e.g., restaurants, National parks, particular cities, each of these can be isolated in terms of popularity score determinations as well.

Still further, a data format for recording popularity scores for geographical areas in accordance with the invention may also include an indication of originating IP addresses, so that, for instance, a chloropleth can be shown that indicates what parts of South America are popular, but based only on data from IP addresses known to be located in Europe. Thus, one can envision the visual representation of foreign interest in a local geographical popularity, or gain greater popularity detail and accuracy for restaurants in a city, e.g., Los Angeles, by recording and displaying only popularity detail data received from IP addresses known to be in Los Angeles, presuming residents of Los Angeles know Los Angeles better than most people that do not live in Los Angeles.

For another example enabled by the invention, imagine that a client is considering purchasing advertising that would be linked to a particular geography. Using the invention, the advertisement the client purchases can be shown when the user is looking at a particular spot of the screen. Being able to see how popular this spot is on the map, and comparing it to the popularity of other spots, might help the user decide whether to purchase the ad.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with processes for representing and displaying geographical popularity information in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods for representing and displaying geographical popularity information of the invention.

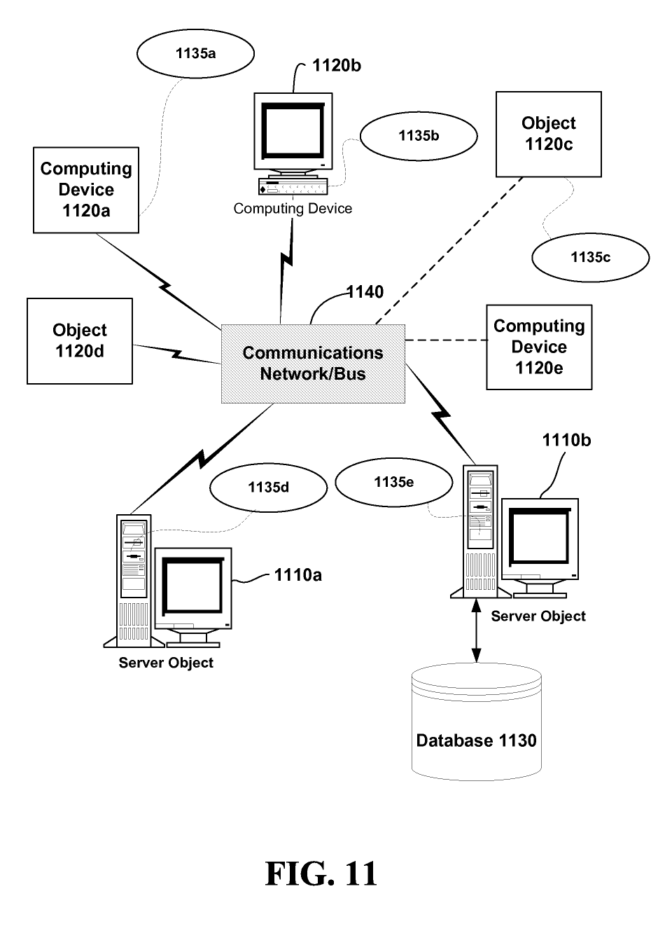

FIG. 11 provides a schematic diagram of an exemplary networked or distributed computing environment. The distributed computing environment comprises computing objects 1110a, 1110b, etc. and computing objects or devices 1120a, 1120b, 1120c, 1120d, 1120e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1140. This network may itself comprise other computing objects and computing devices that provide services to the system of FIG. 11, and may itself represent multiple interconnected networks. In accordance with an aspect of the invention, each object 1110a, 1110b, etc. or 1120a, 1120b, 1120c, 1120d, 1120e, etc. may contain an application that might make use of an API, or other object, software, firmware and/or hardware, suitable for use with the systems and methods for representing and displaying geographical popularity information in accordance with the invention.

It can also be appreciated that an object, such as 1120c, may be hosted on another computing device 1110a, 1110b, etc. or 1120a, 1120b, 1120c, 1120d, 1120e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to representing and displaying geographical popularity information according to the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present invention may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 11, as an example, computers 1120a, 1120b, 1120c, 1120d, 1120e, etc. can be thought of as clients and computers 1110a, 1110b, etc. can be thought of as servers where servers 1110a, 1110b, etc. maintain the data that is then replicated to client computers 1120a, 1120b, 1120c, 1120d, 1120e, etc., although any computer can be considered a client, a server, or both, depending on the circumstances. Any of these computing devices may be processing data or requesting services or tasks that may implicate the processes for representing and displaying geographical popularity information in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for representing and displaying geographical popularity information of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 11 illustrates an exemplary networked or distributed environment, with server(s) in communication with client computer (s) via a network/bus, in which the present invention may be employed. In more detail, a number of servers 1110a, 1110b, etc. are interconnected via a communications network/bus 1140, which may be a LAN, WAN, intranet, GSM network, the Internet, etc., with a number of client or remote computing devices 1120a, 1120b, 1120c, 1120d, 1120e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to represent and display geographical popularity information.

In a network environment in which the communications network/bus 1140 is the Internet, for example, the servers 1110a, 1110b, etc. can be Web servers with which the clients 1120a, 1120b, 1120c, 1120d, 1120e, etc. communicate via any of a number of known protocols such as HTTP. Servers 1110a, 1110b, etc. may also serve as clients 1120a, 1120b, 1120c, 1120d, 1120e, etc., as may be characteristic of a distributed computing environment.

As mentioned, communications may be wired or wireless, or a combination, where appropriate. Client devices 1120a, 1120b, 1120c, 1120d, 1120e, etc. may or may not communicate via communications network/bus 14, and may have independent communications associated therewith. For example, in the case of a TV or VCR, there may or may not be a networked aspect to the control thereof. Each client computer 1120a, 1120b, 1120c, 1120d, 1120e, etc. and server computer 1110a, 1110b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated. Any one or more of computers 1110a, 1110b, 1120a, 1120b, 1120c, 1120d, 1120e, etc. may be responsible for the maintenance and updating of a database 1130 or other storage element, such as a database or memory 1130 for storing data processed or saved according to the invention. Thus, the present invention can be utilized in a computer network environment having client computers 1120a, 1120b, 1120c, 1120d, 1120e, etc. that can access and interact with a computer network/bus 1140 and server computers 1110a, 1110b, etc. that may interact with client computers 1120a, 1120b, 1120c, 1120d, 1120e, etc. and other like devices, and databases 1130.

### Exemplary Computing Device

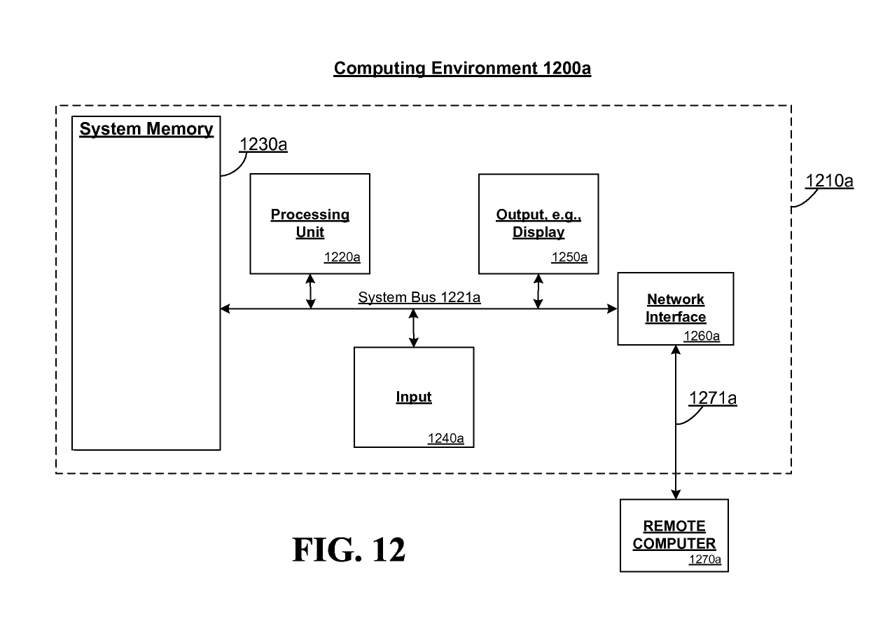

As mentioned, the invention applies to any device wherein it may be desirable to represent and display geographical popularity information. It should be understood, therefore, that handheld, portable and other computing devices and computing objects of all kinds are contemplated for use in connection with the present invention, i.e., anywhere that a device may represent and display geographical popularity information or otherwise receive, process or store data. Accordingly, the below general purpose remote computer described below in FIG. 12 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 12 thus illustrates an example of a suitable computing system environment 1200a in which the invention may be implemented, although as made clear above, the computing system environment 1200a is only one example of a suitable computing environment for a media device and is not intended to suggest any limitation as to the scope of use or functionality of the invention. Neither should the computing environment 1200a be interpreted as having any dependency or requirement relating to any one or combination of components illustrated in the exemplary operating environment 1200a.

With reference to FIG. 12, an exemplary remote device for implementing the invention includes a general purpose computing device in the form of a computer 1210a. Components of computer 1210a may include, but are not limited to, a processing unit 1220a, a system memory 1230a, and a system bus 1221a that couples various system components including the system memory to the processing unit 1220a. The system bus 1221a may be any of several types of bus structures including a memory bus or memory controller, a peripheral bus, and a local bus using any of a variety of bus architectures.

Computer 1210a typically includes a variety of computer readable media. Computer readable media can be any available media that can be accessed by computer 1210a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1210a. Communication media typically embodies computer readable instructions, data structures, program modules or other data in a modulated data signal such as a carrier wave or other transport mechanism and includes any information delivery media.

The system memory 1230a may include computer storage media in the form of volatile and/or nonvolatile memory such as read only memory (ROM) and/or random access memory (RAM). A basic input/output system (BIOS), containing the basic routines that help to transfer information between elements within computer 1210a, such as during start-up, may be stored in memory 1230a. Memory 1230a typically also contains data and/or program modules that are immediately accessible to and/or presently being operated on by processing unit 1220a. By way of example, and not limitation, memory 1230a may also include an operating system, application programs, other program modules, and program data.

The computer 1210a may also include other removable/non-removable, volatile/nonvolatile computer storage media. For example, computer 1210a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1221a through a non-removable memory interface such as an interface, and a magnetic disk drive or optical disk drive is typically connected to the system bus 1221a by a removable memory interface, such as an interface.

A user may enter commands and information into the computer 1210a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1220a through user input 1240a and associated interface(s) that are coupled to the system bus 1221a, but may be connected by other interface and bus structures, such as a parallel port, game port or a universal serial bus (USB). A graphics subsystem may also be connected to the system bus 1221a. A monitor or other type of display device is also connected to the system bus 1221a via an interface, such as output interface 1250a, which may in turn communicate with video memory. In addition to a monitor, computers may also include other peripheral output devices such as speakers and a printer, which may be connected through output interface 1250a.

The computer 1210a may operate in a networked or distributed environment using logical connections to one or more other remote computers, such as remote computer 1270a, which may in turn have media capabilities different from device 1210a. The remote computer 1270a may be a personal computer, a server, a router, a network PC, a peer device or other common network node, or any other remote media consumption or transmission device, and may include any or all of the elements described above relative to the computer 1210a. The logical connections depicted in FIG. 12 include a network 1271a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1210a is connected to the LAN 1271a through a network interface or adapter. When used in a WAN networking environment, the computer 1210a typically includes a communications component, such as a modem, or other means for establishing communications over the WAN, such as the Internet. A communications component, such as a modem, which may be internal or external, may be connected to the system bus 1221a via the user input interface of input 1240a, or other appropriate mechanism. In a networked environment, program modules depicted relative to the computer 1210a, or portions thereof, may be stored in a remote memory storage device. It will be appreciated that the network connections shown and described are exemplary and other means of establishing a communications link between the computers may be used.

### Exemplary Distributed Computing Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the invention may also be implemented via an operating system, or a “middle man” object, a control object, hardware, firmware, intermediate language instructions or objects, etc., such that the methods for representing and displaying geographical popularity information in accordance with the invention may be included in, supported in or accessed via all of the languages and services enabled by managed code, such as .NET code, and in other distributed computing frameworks as well.

There are multiple ways of implementing the present invention, e.g., an appropriate API, tool kit, driver code, operating system, control, standalone or downloadable software object, etc. which enables applications and services to use the systems and methods for representing and displaying geographical popularity information of the invention. The invention contemplates the use of the invention from the standpoint of an API (or other software object), as well as from a software or hardware object that receives a downloaded program in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to represent and display geographical popularity information. For instance, the techniques for representing and displaying geographical popularity information of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes for representing and displaying geographical popularity information of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of FIGS. 5 and 7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fully logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide methods for representing and displaying geographical popularity information. Still further, the present invention may be implemented in or across a plurality of processing chips or devices, and storage may similarly be effected across a plurality of devices. Additionally, for the avoidance of doubt, where utilized herein, the term color should encompass black and white, and shades of grey, and any functions or ranges of any of the foregoing. Therefore, the present invention should not be limited to any single embodiment, but rather should be construed in breadth and scope in accordance with the appended claims.

What is claimed is:

1. A method for visually representing the popularity of a plurality of geographical sub-areas of a geographical area in a computing system, comprising:
retrieving popularity data from a popularity data store corresponding to each of the plurality of geographical sub-areas of the geographical area;
assigning a color to the popularity data for each of the plurality of geographical sub-areas of the geographical area according to a mapping function; and
displaying the geographical area according to the colors assigned to the geographical sub-areas of the geographical area according to said assigning.

2. The method of claim 1, wherein the displaying includes displaying the geographical area at a size determined by a first hierarchical level of detail, and displaying the plurality of geographical sub-areas at a second hierarchical level of detail representing greater detail than the first hierarchical level of detail.

3. The method of claim 1, wherein the displaying includes displaying the geographical area as a chloropleth based on the colors assigned according to said assigning.

4. The method of claim 1, wherein said retrieving includes querying a relational data store representing popularity scores for the plurality of geographical sub-areas, wherein said querying includes specifying a hierarchical level of detail that is associated with each of the plurality of geographical sub-areas for efficient retrieval of the popularity data.

5. The method of claim 1, further including receiving from a user an indication of a geographical location, and based on said indication, determining said geographical area to display to the user and said plurality of geographical sub-areas.

6. The method of claim 5, further comprising, based on said indication, determining a first hierarchical level of detail for said geographical area and determining a second hierarchical level of detail for said plurality of sub-areas, wherein the second hierarchical level of detail represents a greater level of geographical detail than the first hierarchical level of detail.

7. A computing device comprising means for performing the method of claim 1.

8. A user interface in a computing system for displaying geographical popularity data for a geographical region, comprising:
a geographical region user interface element that displays a geographical region at a first level of detail; and
a plurality of geographical sub-region user interface elements displayed within the geographical region, wherein each of the plurality of geographical sub-region user interface elements represents a second level of detail greater in detail than the first level of detail,
wherein each geographical sub-region user interface element is displayed with a color derived from a function of a popularity information retrieved for the geographical sub-region user interface element from a popularity information data store representing popularity information for the plurality of geographical sub-regions represented by the plurality of geographical sub-region user interface elements.

9. The user interface of claim 8, wherein the plurality of geographical sub-region user interface elements are displayed as a chloropleth within the geographical region user interface element according to said colors.

10. The user interface of claim 8, wherein the second level of detail represented by the plurality of geographical sub-region user interface elements corresponds to a hierarchical level of the names of the plurality of geographical sub-region user interface elements as stored in the popularity information data store.

11. The user interface of claim 8, wherein the function for determining a color for each of the geographical sub-region user interface elements based on the popularity information is a mapping function that maps a range of popularity scores for the geographical sub-region user interface elements to a pre-defined range of colors that ranges from a starting color to an ending color.

12. The user interface of claim 8, wherein the popularity information of the popularity information data store includes a popularity score for each of the geographical sub-region user interface elements, and the popularity scores of the geographical sub-region user interface elements are updated each time a pre-defined class of user interaction occurs anywhere in the computing system with respect to any geographical region represented by any of the plurality of geographical sub-region user interface elements.

13. A method for representing the popularity of a plurality of sub-regions of a geographical region in a computing system, comprising:
each time a user interacts with a geographical sub-region of a plurality of sub-regions in a software application,
recording a log record for said geographical sub-region in a popularity data store storing popularity information for each of the plurality of geographical sub-regions; and
determining a popularity score for the geographical sub-region based on the log record representing the user's interaction with the geographical sub-region of the plurality of sub-regions.

14. The method of claim 13, further comprising:
determining the log record from a record of at least one of a pre-existing web log store or a pre-existing usage log store.

15. The method of claim 13, wherein the recording includes recording a log record according to a pre-defined data format, and the recording includes recording a name field indicative of the name of the geographical sub-region with which the user interacted.

16. The method of claim 15, wherein the recording includes recording a hierarchical name field formatted according to a hierarchical naming convention, whereby the hierarchical name field represents a hierarchical level of detail represented by the geographical sub-region.

17. The method of claim 13, wherein the recording includes recording a log record according to a pre-defined data format, and the recording includes recording a temporal field indicative of a time of the user's interaction.

18. The method of claim 13, wherein the recording includes recording a log record according to a pre-defined data format, and the recording includes recording a sub-region display style field indicative of display style for the geographical sub-region.

19. The method of claim 13, wherein the recording includes recording a log record according to a pre-defined data format, and the recording includes recording an originating IP address of a computing device where the user interacted with the geographical sub-region.

20. A computer readable medium comprising computer executable instructions for performing the method of claim 13.
